(19) United States
(12) Patent Application Publication
(10) Pub. No.: US 2012/0297758 A1
(43) Pub. Date: Nov. 29, 2012

(54) Large Displacement Variator

(75) Inventors: Bryan Edward Nelson, Lacon, IL (US); Jeffrey Kuehn, Germantown Hills, IL (US)

(73) Assignee: CATERPILLAR, INC., Peoria, IL (US)

(21) Appl. No.: 13/113,491

(22) Filed: May 23, 2011

(51) Int. Cl. F16D 39/00

(52) U.S. Cl. 60/327; 60/487

(57) ABSTRACT

A large displacement hydrostatic variator is disclosed which includes an input shaft coupled to at least first and second hydrostatic pumps. Two hydrostatic pumps are utilized instead of one larger hydrostatic pump because it has been found the two smaller hydrostatic pumps can operate at a faster speed than a larger hydrostatic pump with a displacement equivalent to that of the two smaller hydrostatic pumps. Each hydrostatic pump may include a carrier that includes a plurality of recesses. The recesses may serve as cylinders for slidably accommodating a piston in each piston of each pump may be pivotally coupled to an adjustable swash plate. A hydrostatic motor may be coupled to an output shaft. The motor includes a carrier that also includes a plurality of recesses that may also serve as cylinders for each slidably accommodating a piston. Each piston of the motor may be coupled to a swash plate. The adjustable swash plate of each pump may be coupled to an actuator, which may be controlled by a single controller.

### TECHNICAL FIELD

This disclosure relates generally to continuously variable transmissions (CVTs) and, more particularly to variators for a CVT or similar transmissions that are capable of large displacements and high speeds for use in such transmissions.

### BACKGROUND

Machines, such as wheel loaders, track loaders, bulldozers, backhoes etc. typically use a transmission to translate the rotational speed of an engine to move the machine or operate an implement of the machine. These transmissions are generally operable to provide a series of gear ratios that translate the speed of the engine into different drive speeds or implement operating speeds. Various hydrostatic or hydrostatic transmissions are available. One type of hydrostatic transmission is known as a continuously variable transmission (CVT). One type of CVT is known as a parallel path variable transmission (PPVT) which is a combination of a variable hydrostatic transmission such as a CVT with a mechanical transmission. Also, a split torque transmission may be employed that also combines a CVT with a mechanical transmission.

In both CVTs and PPVTs, the power source or engine rotates an input shaft that drives a variable displacement hydrostatic pump. The pump transmits rotation to a variable or fixed displacement hydrostatic motor, which rotates the planetary gear set of the drive train or work implement. CVTs and PPVTs may allow for a smooth transmission through a series of effective transmission ratios. CVTs and PPVTs may provide a somewhat continuously variable range of transmission ratios without excessive and distinctive “shifts” between fixed gears. The input to a CVT or PPVT may be from a device known as a variator.

A variator is a hydrostatic device that includes a hydrostatic pump coupled to a hydrostatic motor in such a way that the speed or torque output can be varied by varying a parameter of the pump, such as a swash plate setting or angle.

US2009/0298635 discloses a hydrostatic variator that includes various forms of electric actuators for controlling the angle of the swash plate of the variable displacement hydrostatic pump. However, larger displacements, faster speeds and/or greater torques are desired for many applications. Thus, improved hydrostatic variators are needed.

### SUMMARY OF THE DISCLOSURE

A hydrostatic variator is disclosed that includes an input shaft coupled to at least first and second hydrostatic pumps. Each hydrostatic pump includes a carrier that includes a plurality of recesses that serve as cylinders for slidably accommodating a piston. Each piston of each hydrostatic pump may be pivotally coupled to an adjustable swash plate. A hydrostatic motor may be coupled to an output shaft. The motor includes a carrier that includes a plurality of recesses that similarly function as cylinders for slidably accommodating a piston. Each piston of the motor may be coupled to an adjustable or non-adjustable swash plate. The adjustable swash plate of each hydrostatic pump may be coupled to a single actuator.

A variable transmission is disclosed that includes a hydrostatic variator that includes an input shaft coupled to first and second hydrostatic pumps. Each hydrostatic pump includes a carrier that includes a plurality of recesses where in each recess serves as a cylinder for slidably accommodating a piston. Each piston of each pump may be pivotally coupled to an adjustable swash plate. A hydrostatic motor may be coupled to an output shaft. Each recess of the motor also similarly serves as a cylinder for slidably accommodating a piston. Each piston of the motor may be coupled to an adjustable or non-adjustable swash plate. Each recess of the motor may be in communication with one recess of each pump. The adjustable swash plate of each pump may be coupled to a single actuator. The actuator may include a cylinder divided into first and second sections, which are isolated from one another. The actuator may further include a shaft passing through both sections. The shaft may include a first end coupled to the swash plate of the first pump and a second end coupled to the swash plate of the second pump.

A method for increasing the displacement of a variable transmission is disclosed. The method includes providing a hydrostatic variator including an input shaft coupled to a first hydrostatic pump. The first hydrostatic pump includes a carrier including a plurality of recesses. Each recess of the first pump slidably accommodates a piston. The piston of the first pump may be pivotally coupled to an adjustable swash plate. The method includes coupling a second hydrostatic pump to the input shaft. The second hydrostatic pump also includes a plurality of recesses wherein each recess of the second pump slidably accommodates a piston. The pistons of the second pump are coupled to an adjustable swash plate. The method further includes coupling the adjustable swash plates of the first and second pumps to a single actuator. The single actuator includes a cylinder divided into first and second isolated sections. The actuator further includes a shaft passing through both sections. The shaft includes a first end coupled to the swash plate of the first pump and a second end coupled to the swash plate of the second pump. The method further includes providing a hydrostatic motor coupled to an output shaft. Each recess of the motor also slidably accommodates a piston.

### BRIEF DESCRIPTION OF THE DRAWINGS

FIG. 1 is a side view of one exemplary machine suitable for incorporating the disclosed large displacement variator and/or improved variable transmission.

FIG. 2 is a schematic illustration of two hydrostatic pumps linked to a hydrostatic motor and a single actuator for purposes of providing a large displacement variator in accordance with this disclosure.

FIG. 3 is a hydrostatic circuit diagram of the disclosed large displacement variator as incorporated into a hydrostatic transmission.

### DETAILED DESCRIPTION

Reference will now be made in detail to specific embodiments or features, examples of which are illustrated in the accompanying drawings. Generally, corresponding reference numbers will be used throughout the drawings to refer to the same or corresponding parts.

FIG. 1 illustrates an exemplary machine 10 having multiple systems and components that cooperate to accomplish a variety of tasks. The tasks performed by the machine 10 may be associated with particular industries such as mining, construction, farming, transportation, power generation or any other industry known in the art. For example, the machine 10 may embody a mobile machine such as the wheel loader depicted in FIG. 1, a bus, a highway haul truck, or any other mobile machine known in the art. The machine 10 may include one or more traction devices 11 and a power train 12 connected to drive at least one of the traction devices 11. The traction devices 11 may embody wheels located on each side of the machine 10 (only one side shown). Alternatively, the traction devices 11 may include tracks, belts or other known traction devices. It is contemplated that any combination of the wheels on the machine 10 may be driven and/or steered.

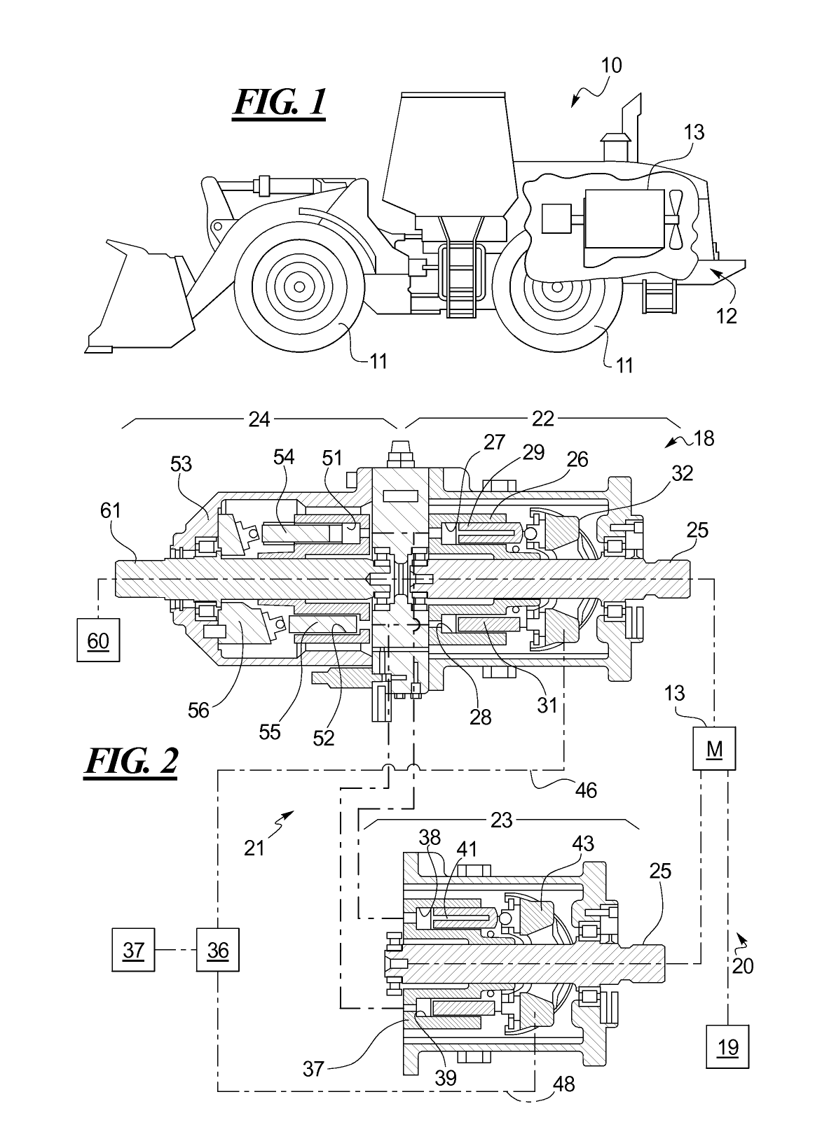

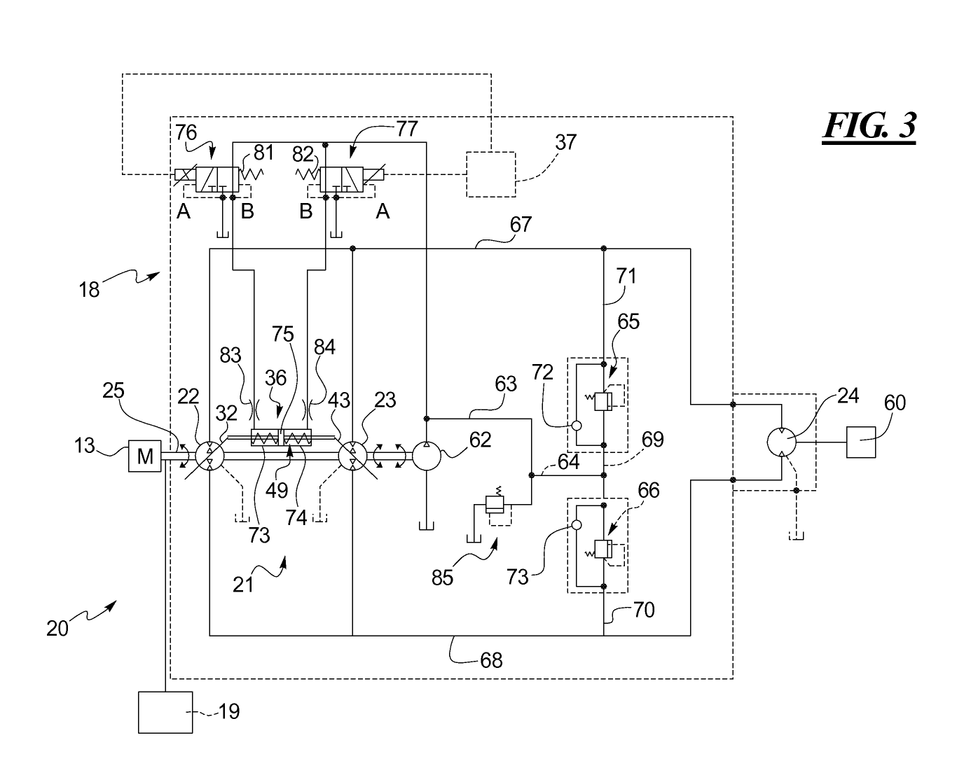

As shown in FIGS. 2-3, the power train 12 may include components that work together to propel the machine 10. Specifically, the power train 12 may include a power source 13 or prime mover drivingly coupled to a transmission 20, only part of which is shown in FIG. 2 (see FIG. 3). The transmission 20 may be a variable transmission such as a continuously variable transmission (CVT) or a parallel path variable transmission (PPVT). In the embodiment shown in FIGS. 2 and 3, the transmission 20 may be a PPVT as it includes a hydrostatic transmission 18 with the pumps 22, 23 and motor 24 (FIG. 3) and a mechanical transmission 19 (FIG. 3), which will not be discussed in detail here. See, e.g., U.S. Pat. No. 7,530,913.

Returning to FIG. 2, the transmission 20 includes a variator 21. The variator 21 includes a first hydrostatic pump 22, a second hydrostatic pump 23 and a hydrostatic motor 24. The power source 13 (or engine or prime mover) may be coupled to an input shaft 25. As illustrated in FIGS. 2 and 3, the input shaft 25 couples the power source 13 to both the first pump 22 and the second pump 23. Referring to FIG. 2, the first pump 22 may include a carrier 26 or body or block. The carrier 26 includes a plurality of recesses, two of which are shown at 27, 28, which serve as cylinders for accommodating the pistons 29, 31. Typically, the first pump 22 would include several recesses arranged concentrically around the shaft 25. The pistons 29, 31 may be linked to an adjustable swash plate 32 by slippers or another suitable means. The slippers may be pivotally coupled to the swash plate 32 and the swash plate 32 may be pivotally coupled to the input shaft 25. The swash plate 32 may also be coupled to the actuator 36 by the linkage 46, which is shown schematically.

The second pump 23 also includes a carrier 37 that includes a plurality of recesses, two of which are shown at 38, 39, that serve as cylinders for the pistons, two of which are shown at 41, 42. The pistons 41, 42 may be linked to the adjustable swash plate 43 by the slippers. The slippers may be pivotally connected to the swash plate 43 and the swash plate 43 may be pivotally connected to the input shaft 25. The swash plate 43 may also be coupled to the actuator 36 by the linkage 48.

The recesses 27, 28, 38, 39 of the pumps 22, 23, which may vary in number, are linked to the motor 24 as follows. In the position shown in FIG. 2, the recesses 27, 38 are in communication with the recess 51 and the recesses 28, 39 are in communication with the recess 52. The recesses 51, 52 may be disposed in a carrier 53 and serve as cylinders for the pistons 54, 55. The pistons 54, 55 may be linked to the fixed swash plate 56 by slippers or another suitable mechanism. The motor 24 may be coupled to the output shaft 61, which drives the planetary gear set 60 or other suitable mechanism, as will be appreciated to one of ordinary skill in the art. The actuator 36 may be linked to the controller 37 and the swash plate 43 by the linkage.

As illustrated further in FIG. 3, a single actuator 36 may be used to control the adjustable swash plates 32, 43 of the two hydrostatic pumps 22, 23. It has been surprisingly found that the use of two smaller pumps 22, 23 provides increased displacement and speed versus a single larger pump of greater capacity. Specifically, two smaller pumps 22, 23 may operate at faster speeds than a larger pump thereby increasing the displacement of two small pumps 22, 23 versus a larger pump having a same or greater displacement capacity. The increased displacement results in greater motor speed.

Many types of actuators 36 are available for controlling swash plates 32, 43, as will be appreciated by those skilled in the art. In the example shown, the actuator 36 includes a cylinder or housing 49 divided into two sections 73, 74 by a wall 75 or other suitable dividing or isolating mechanism. Each section 73, 74 of the actuator 36 may be controlled by a pressure control valves 76, 77, but other types of actuators may be controlled directly by the controller 37.

Returning to FIG. 3, the power source 13 may be coupled to the input shaft 25 which rotates the hydrostatic pumps 22, 23 as well as a hydraulic charge pump 62, which may be used in a closed-circuit design as shown in FIG. 3. The charge pump may be separate from the variator 21. Open circuit designs are also available for purposes of practicing the disclosed variators, transmissions and methods as will be apparent to those skilled in the art.

The purpose of the charge pump 62 may be to maintain pressure on the low pressure side of the motor 24, which may be both variable in displacement and reversible in direction. Specifically, the charge pump 62 delivers fluid through the lines 63, 64 to the integrated crossover relief valves 65, 66 and makeup checks 72, 73 which, as shown in FIG. 3, are normally in a closed position. However, when the pressure in one of the supply/return lines 67, 68 exceeds that of the other, fluid from the charge pump 62 will be directed toward the low pressure supply/return line 67, 68.

For example, if the supply/return line 67 is at high pressure, the high pressure will be communicated through the line 71 thereby closing the check valve 72. Fluid pressure from the charge pump 62 is typically not sufficient to open check valve 72. Since supply/return line 70 is at a low pressure, fluid pressure from charge pump 62 may overcome check valve 73 and supply fluid to line 70. The rate of fluid supplied is nearly equal to what is lost through internal leakage of the pumps 22, 23 and motor 24 and any fluid used by the pump controls 36, 46, 48.

Of course, because the pump 24 is a two way pump, the reverse is true if the supply/return line 68 is the high pressure line. Pressure from the line 68 would pass through the line 70 and open the relief valve 66 and be blocked from circumventing the relief valve 66 by the check valve 73. However, the check valve 72 will permit fluid to flow around the relief valve 65 and through the line 71 to provide the needed pressure to the low pressure line 67.

Returning to the actuator 36, control of the actuator 36 may be provided by the two actuator pressure control valves 76, 77. Pilot fluid may be provided to the pressure control valves 76, 77 by the charge pump 62. Each pressure control valve 76, 77 includes a solenoid which may be controlled by the controller 37. As shown, the pressure relief valves 76, 77 are preferably a three port, two way solenoid-activated valves that are normally open as indicated by the springs 81, 82. The flow control valves 83, 84 are disposed between the pressure control valves 76, 77 and the actuator 36. One or both of the flow control valves 83, 84 (or restrictors) may be controllable as indicated by the control valve 83 or fixed as indicated by the control valve 84. An additional pressure relief valve is shown at 85 may be employed to limit the pressure of the fluid delivered to the pressure control valves 76, 77 by the charge pump 62.

Another option is to include the variator 21 as a part of a single pressure control valve.

### INDUSTRIAL APPLICABILITY

In operation, the power source 13 rotates the input shaft 25 which, in turn, rotates the hydrostatic pump 22, 23 and charge pump 62, which may be separate from the variator. The output of the pumps 22, 23 may be controlled by the pressure control valve 76, 77 and controller 37. The pressure delivered to the supply/return lines 67 or 68 (depending upon the direction of rotation of the input shaft 25) may be determined by a single actuator 36 which controls the position of both swash plates 32, 43. As noted above, two smaller pumps 22, 23 can operate at faster RPM's than a larger pump with the same or equivalent displacement.

To increase the displacement of the variator 21, a second hydrostatic pump 23 may be mounted to the input shaft 25, which may need to be extended or a longer input shaft 25 may be needed. An additional pressure control valve 77 may be added in parallel to the pressure control valve 76. A single actuator per pump 22, 23, or two in total, may be replaced by the one double actuator 36 shown in FIG. 3. As noted above, other actuation schemes other than the hydrostatic actuator 36 are available, as will be appreciated to those skilled in the art.

What is claimed is:

1. A hydrostatic variator comprising:
an input shaft coupled to at least first and second hydrostatic pumps,
each hydrostatic pump including a carrier including a plurality of recesses, each recess of each pump slidably accommodating a piston, each piston of each pump pivotally coupled to an adjustable swash plate;
a hydrostatic motor coupled to an output shaft, the motor including a carrier including a plurality of recesses, each recess of the motor slidably accommodating a piston, each piston of the motor being coupled to a swash plate;
each recess of the motor is in communication with one recess of each pump;
the adjustable swash plate of each pump being coupled to an actuator.

2. The variator of claim 1 wherein the actuator comprises first and second sections that are isolated from one another, the variator further including a shaft passing through both sections, the shaft comprising a first end coupled to the swash plate of the first pump and a second end coupled to the swash plate of the second pump.

3. The variator of claim 2 wherein the first and second sections of the actuator in communication with first and second control valves respectively.

4. The variator of claim 3 wherein the first and second control valves each include solenoids, each solenoid linked to a controller.

5. The variator of claim 3 wherein the first and second control valves are in communication with a charge pump.

6. The variator of claim 5 wherein the charge pump is coupled to the input shaft.

7. The variator of claim 1 wherein the charge pump is not coupled to the input shaft.

8. The variator of claim 1 wherein the input shaft is coupled to a prime mover.

9. The variator of claim 1 wherein the swash plate of the motor is non-adjustable.

10. The variator of claim 1 wherein the swash plate of the motor is adjustable.

11. A variable transmission comprising:
a hydrostatic variator including an input shaft coupled to first and second hydrostatic pumps, each hydrostatic pump including a carrier including a plurality of recesses, each recess of each pump slidably accommodating a piston, each piston of each pump pivotally coupled to an adjustable swash plate;
a hydrostatic motor coupled to an output shaft, the motor including a carrier including a plurality of recesses equal in number to the plurality of recesses disposed in the carriers of the first and second pumps, each recess of the motor slidably accommodating a piston, each piston of the motor being coupled to a swash plate;
the adjustable swash plate of each pump being coupled to an actuator, the actuator includes a housing divided into first and second sections that are isolated from one another, the actuator further including a shaft passing through both sections, the shaft includes a first end coupled to the swash plate of the first pump and a second end coupled to the swash plate of the second pump;
the actuator being controlled by a single controller.

12. The transmission of claim 11 wherein the first and second sections of the actuator are coupled to first and second control valves respectively.

13. The transmission of claim 12 wherein the first and second control valves each include solenoids, each solenoid linked to the single controller.

14. The transmission of claim 13 wherein the first and second control valves are in communication with a charge pump.

15. The transmission of claim 14 wherein the charge pump is coupled to the input shaft.

16. The transmission of claim 1 wherein the input shaft is coupled to a prime mover.

17. A method for increasing the displacement of a variable transmission, the method comprising:
providing a hydrostatic variator including an input shaft coupled to a first hydrostatic pump, the first hydrostatic pump including a carrier including a plurality of recesses, each recess of the first pump slidably accommodating a piston, the pistons of the first pump pivotally are coupled to an adjustable swash plate;
coupling a second hydrostatic pump to the input shaft, the second hydrostatic pump including a carrier including a plurality of recesses, each recess of the second pump slidably accommodating a piston, the pistons of the second pump pivotally are coupled to an adjustable swash plate;
coupling the adjustable swash plate of the first and second pumps to a single actuator, the single actuator includes a cylinder divided into first and second isolated sections, the actuator further including a shaft passing through both sections, the shaft including a first end coupled to the swash plate of the first pump and a second end coupled to the swash plate of the second pump;
providing a hydrostatic motor coupled to an output shaft, the motor including a carrier including a plurality of recesses, each recess of the motor slidably accommodating a piston, each piston of the motor being coupled to a swash plate;
providing communication between the recesses of the motor and the recesses of each pump;
controlling the actuator with a single controller.

18. The method of claim 17 further including coupling the first and second sections of the actuator to first and second control valves respectively.

19. The method of claim 18 further including linking the first and second control valves to the single controller.

20. The method of claim 17 wherein the swash plate of the motor is adjustable.
